(19) United States
(12) Patent Application Publication
(10) Pub. No.: US 2014/0062583 A1
(43) Pub. Date: Mar. 6, 2014

(54) INTEGRATED CIRCUIT AND METHOD OF OPERATING THE SAME

(71) Applicant: SK HYNIX INC., Gyeonggi-do (KR)

(72) Inventors: Chae-Kyu JANG, Gyeonggi-do (KR); Jong-Hyun WANG, Gyeonggi-do (KR); Hyun-Chul LEE, Gyeonggi-do (KR); Jong-Ki NAM, Gyeonggi-do (KR)

(73) Assignee: SK hynix Inc., Gyeonggi-do (KR)

(21) Appl. No.: 13/717,218

(22) Filed: Dec. 17, 2012

(30) Foreign Application Priority Data
Aug. 29, 2012 (KR) 10-2012-0095044

(51) Int. Cl. G05F 1/10

(52) U.S. Cl. CPC G05F 1/10
USPC 327/538

(57) ABSTRACT

An integrated circuit includes a first internal voltage generation unit configured to generate a first voltage and output the first voltage through an internal voltage terminal in an active operation period, a second internal voltage generation unit configured to generate a second voltage and output the second voltage through the internal voltage terminal in an initial section of a standby operation period, and a third internal voltage generation unit configured to generate a third voltage and output the third voltage through the internal voltage terminal in the remaining section of the standby operation period.

### CROSS-REFERENCE TO RELATED APPLICATIONS

The present application claims priority of Korean Patent Application No. 10-2012-0095044, filed on Aug. 29, 2012, which is incorporated herein by reference in its entirety.

### BACKGROUND

1. Field

Exemplary embodiments of the present invention relate to semiconductor design technology, and more particularly, to an integrated circuit having various types of operating modes.

2. Description of the Related Art

In general, an integrated circuit, such as double data rate synchronous DRAM (DDR SDRAM), performs various types of operations and includes internal circuits for performing the operations. With the gradual development of process technology, the size of the internal circuits is gradually reduced. In order to operate the internal circuits, a power source is necessary. Accordingly, a power source circuit is recently designed by taking this situation into account.

Meanwhile, an integrated circuit has various types of operating modes and performs a corresponding circuit operation depending on a corresponding operating mode. The various types of operating modes may include an active operation mode and a standby operating mode, for example. The standby operating mode is an operating mode for reducing power consumption. In general smaller driving force compared to driving force used in the active operation mode is used in the standby operating mode. In other words, operating voltages used in the active operation mode and the standby operating mode have the same level, but driving force is different in the active operation mode and the standby operating mode. In this state, in the case of an internal circuit in which a leakage current path is formed in the active operation mode, a leakage current path is also formed in the standby operating mode. This means that unnecessary current consumption is generated in the standby operating mode.

### SUMMARY

Exemplary embodiments of the present invention are directed to provide an integrated circuit capable of controlling a power source generation circuit depending on an operating mode.

In accordance with an embodiment of the present invention, an integrated circuit includes a first internal voltage generation unit configured to generate a first voltage and output the first voltage through an internal voltage terminal in an active operation period, a second internal voltage generation unit configured to generate a second voltage and output the second voltage through the internal voltage terminal in a initial section of a standby operation period, and a third internal voltage generation unit configured to generate a third voltage and output the third voltage through the internal voltage terminal in the remaining section of the standby operation period.

In accordance with another embodiment of the present invention, an integrated circuit includes an active internal voltage generation unit configured to generate an active voltage and output the active voltage through an internal voltage terminal in an active operation period, a first standby internal voltage generation unit configured to generate a first standby voltage and output the first standby voltage through the internal voltage terminal in a initial section of a standby operation period, and a second standby internal voltage generation unit configured to generate a second standby voltage and output the second standby voltage through the internal voltage terminal in the remaining section of the standby operation period.

In accordance with yet another embodiment of the present invention, a method of operating an integrated circuit includes driving an internal voltage terminal with an active voltage in an active operation period, driving the internal voltage terminal with a standby voltage in a standby operation period, and driving the internal voltage terminal with a voltage between the active voltage and the standby voltage in a period between the active operation period and the standby operation period.

There is an advantage in that unnecessary current consumption may be prevented because the formation of a leakage current path in an internal circuit is minimized although an estimated operating mode is performed.

### BRIEF DESCRIPTION OF THE DRAWINGS

FIG. 1 is a circuit diagram illustrating an integrated circuit in accordance with an embodiment of the present invention.

FIG. 2 is a circuit diagram illustrating a control signal generation unit for generating first to third control signals shown in FIG. 1.

FIG. 3 is a timing diagram illustrating the operation of the integrated circuit shown in FIGS. 1 and 2.

### DETAILED DESCRIPTION

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention. In this specification, ‘connected/coupled’ represents that one component is directly coupled to another component or indirectly coupled through another component. In this specification, a singular form may include a plural form as long as it is not specifically mentioned in a sentence.

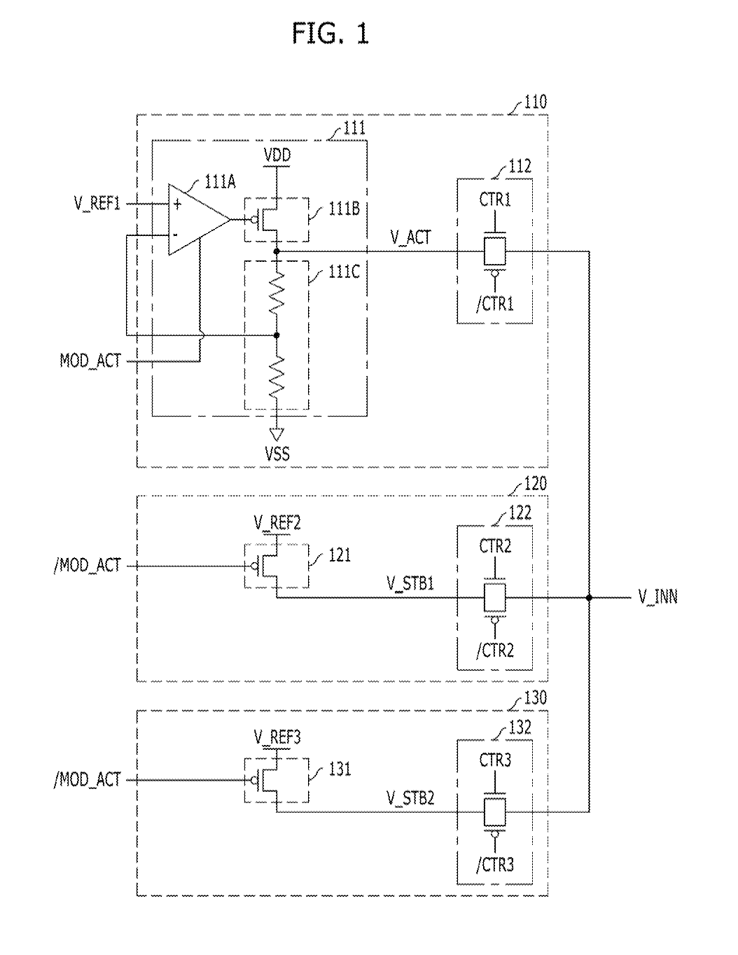

FIG. 1 is a circuit diagram illustrating an integrated circuit in accordance with an embodiment of the present invention.

Referring to FIG. 1, the integrated circuit includes an active internal voltage generation unit 110, a first standby voltage generation unit 120, and a second standby voltage generation unit 130.

The active internal voltage generation unit 110 is configured to generate an active voltage V_ACT in response to an active mode signal MOD_ACT enabled in an active operation period and output the active voltage V_ACT through an internal voltage terminal V_INN. The active internal voltage generation unit 110 includes a comparison type voltage generation unit 111 and a first transfer unit 112. The comparison type voltage generation unit 111 includes a comparison unit 111A, a driving unit 111B, and a feedback unit 111C which form a feedback loop and generates the active voltage V_ACT, corresponding to a first reference voltage V_REF1, through the comparison operation of the comparison unit 111A. The first transfer unit 112 transfers the active voltage V_ACT to the internal voltage terminal V_INN in response to first control signals CTR1 and /CTR1

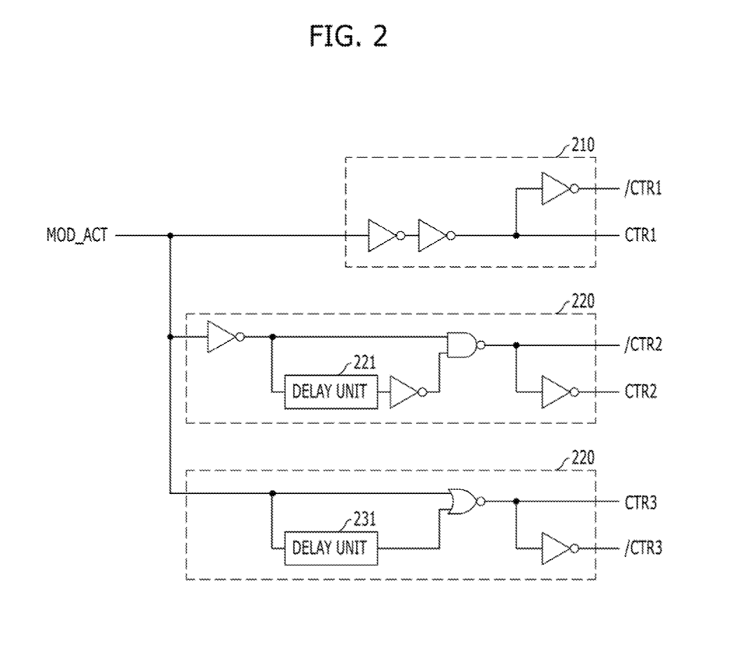

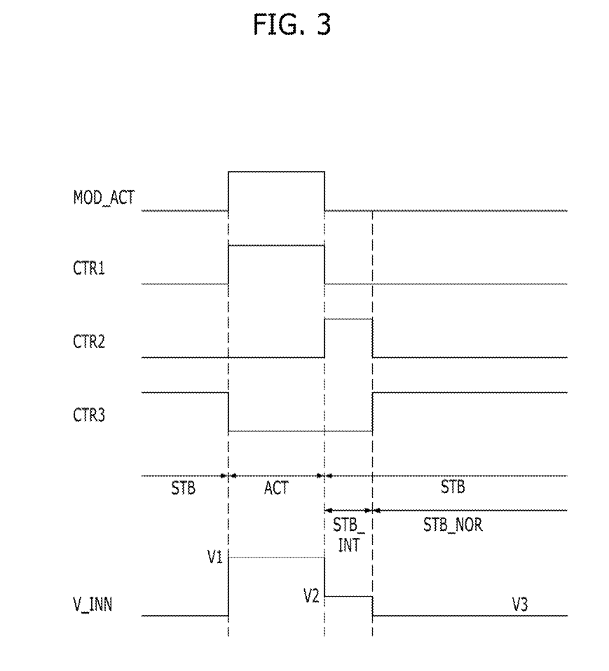

The first control signals CTR1 and /CTR1 and second control signals CTR2 and /CTR2 and third control signals CTR3 and /CTR3 to be described later are described in detail with reference to FIGS. 2 and 3.

The first standby voltage generation unit 120 is configured to generate a first standby voltage V_STB1 in an initial section of a standby operation period and output the first standby voltage V_STB1 through the internal voltage terminal V_INN. The first standby voltage generation unit 120 includes a first short circuit type voltage generation unit 121 and a second voltage transfer unit 122. The first short circuit type voltage generation unit 121 has a different construction from the comparison type voltage generation unit 111 and outputs a second reference voltage V_REF2 as the first standby voltage V_STB1 through the short circuit operation of the first short circuit type voltage generation unit 121. The second voltage transfer unit 122 transfers the first standby voltage V_STB1 to the internal voltage terminal V_INN in response to the second control signals CTR2 and /CTR2.

The second standby voltage generation unit 130 is configured to generate a second standby voltage V_STB2 in a standby operation period and output the second standby voltage V_STB2 through the internal voltage terminal V_INN. The second standby voltage generation unit 130 includes a second circuit short type voltage generation unit 131 and a third voltage transfer unit 132. The second short circuit type voltage generation unit 131 has a different construction from the comparison type voltage generation unit 111 similar to the first short circuit type voltage generation unit 121 and outputs a third reference voltage V_REF3 as the second standby voltage V_STB2 through the short circuit operation of the second short circuit type voltage generation unit 131. The third voltage transfer unit 132 transfers the second standby voltage V_STB2 to the internal voltage terminal V_INN in response to the third control signals CTR3 and /CTR3.

FIG. 2 is a circuit diagram illustrating a control signal generation unit for generating the first to third control signals shown in FIG. 1.

Referring to FIG. 2, the control signal generation unit includes a first control signal generator 210 for generating the first control signals CTR1 and /CTR1 in response to an active mode signal MOD_ACT in the active operation period, a second control signal generator 220 for generating the second control signals CTR2 and /CTR2 in response to the active mode signal MOD_ACT in the standby operation period, and a third control signal generator 230 for generating the third control signals CTR3 and /CTR3 in response to the active mode signal MOD_ACT in the standby operation period.

The periods in which the second control signals CTR2 and /CTR2 and the third control signals CTR3 and /CTR3 are enabled may be set by delay units 221 and 231 included in the second and the third control signal generators 220 and 230, respectively. The amount of delay of the delay unit 221 and the amount of delay of the delay unit 231 may be set identically so that the enable period of the second control signals CTR2 and /CTR2 and the enable period of the third control signals CTR3 and /CTR3 do not overlap with each other. For a stable circuit operation, the amount of delay of the delay unit 221 and the amount of delay of the delay unit 231 may be set differently so that the enable period of the second control signals CTR2 and /CTR2 slightly overlaps with the enable period of the third control signals CTR3 and /CTR3.

FIG. 3 is a timing diagram illustrating the operation of the control signal generation unit of FIGS. 1 and 2.

The active mode signal MOD_ACT, the first control signals CTR1 and /CTR1, the second control signals CTR2 and /CTR2, and the third control signals CTR3 and /CTR3 are shown in FIG. 3. In the first control signals CTR1 and /CTR1, the second control signals CTR2 and /CTR2, and the third control signals CTR3 and /CTR3, CRR1, CRR2, and CRR3 are shown as the first control signal, the second control signal and the third control signal, respectively, for convenience of description.

First, a period in which the active mode signal MOD_ACT is in a logic low level means the standby operation period STB, and a period in which the active mode signal MOD_ACT is in a logic high level means the active operation period ACT. In the integrated circuit in accordance with an embodiment of the present invention, the standby operation period STB is divided into the initial section of the standby operation period STB_INT and a standby operation normal period STB_NOR.

Referring to FIGS. 1 to 3, first, in the active operation period ACT, the comparison type voltage generation unit 111 of the first active internal voltage generation unit 110 is enabled, thus generating the active voltage V_ACT. Next, since the first control signal CTR1 is enabled in the active operation period ACT, the active voltage V_ACT is transferred to the internal voltage terminal V_INN. Here, the internal voltage V_INN may become a first internal voltage level V1 corresponding to the first reference voltage V_REF1.

Next, in the initial section of the standby operation period STB_INT of the standby operation period STB, the first short circuit type voltage generation unit 121 of the first standby voltage generation unit 120 is enabled, thus generating the first standby voltage V_STB1. Next, since the second control signal CTR2 is enabled in the initial section of the standby operation period STB_INT, the first standby voltage V_STB1 is transferred to the internal voltage terminal V_INN. Here, the internal voltage V_INN may become a second internal voltage level V2 corresponding to the second reference voltage V_REF. The second internal voltage level V2 is lower than the first internal voltage level V1, but is higher than a third internal voltage level V3.

Next, in the standby operation normal period STB_NOR of the standby operation period STB, the second short circuit type voltage generation unit 131 of the second standby voltage generation unit 130 is enabled, thus generating the second standby voltage V_STB2. Next, since the third control signal CTR3 is enabled in the standby operation normal period STB_NOR, the second standby voltage V_STB2 is transferred to the internal voltage terminal V_INN. Here, the internal voltage V_INN may become the third internal voltage level V3 corresponding to the third reference voltage V_REF.

On the one hand, the comparison type voltage generation unit 111 has large driving force, but a leakage current path is formed in the comparison type voltage generation unit 111 when the circuit operates. The first and the second short circuit type voltage generation units 121 and 131 have small driving force, but a leakage current path is not formed in the first and the second short circuit type voltage generation units 121 and 131 when the circuit operates. In other words, the integrated circuit in accordance with an embodiment of the present invention may increase driving force in the active operation period ACT and prevent a leakage current path from being formed in the standby operation period STB because the comparison type voltage generation unit 111 is used in the active operation period ACT and the first and the second short circuit type voltage generation units 121 and 131 are used in the standby operation period STB. As a result, unnecessary current consumption may be prevented.

On the other hand, if the active operation period ACT is changed into the standby operation period STB, that is, if the first internal voltage level V1 in which the internal voltage terminal V_INN has a very high level is changed into the third internal voltage level V3 in which the internal voltage terminal V_INN has a very low level, a power inefficiency phenomenon may occur in the integrated circuit. In the integrated circuit in accordance with an embodiment of the present invention, the internal voltage terminal V_INN may be driven at the second internal voltage level V2 having a level between the first internal voltage level V1 and the third internal voltage level V3 for a specific time in the period in which the active operation period ACT is changed into the standby operation period STB. Accordingly, the inefficient power consumption may be prevented.

As described above, the integrated circuit in accordance with an embodiment of the present invention may maximize operation efficiency in generating the internal voltage terminal V_INN and may minimize unnecessary power consumption. Furthermore, malfunction may be prevented because inefficient power consumption may be reduced.

Furthermore, the position and type of the logic gates and the transistors illustrated in the above embodiments may be differently embodied depending on the polarity of a signal.

While the present invention has been described with respect to the specific embodiments, it will be apparent to those skilled in the art that various changes and modifications may be made without departing from the spirit and scope of the invention as defined in the following claims.

1. An integrated circuit, comprising:
a first internal voltage generation unit configured to generate a first voltage and output the first voltage through an internal voltage terminal in an active operation period;
a second internal voltage generation unit configured to generate a second voltage and output the second voltage through the internal voltage terminal in an initial section of a standby operation period; and
a third internal voltage generation unit configured to generate a third voltage and output the third voltage through the internal voltage terminal in the remaining section of the standby operation period,
wherein the second internal voltage generation unit and the third internal voltage generation unit generate the second voltage and the third voltage in the standby operation period.

2. The integrated circuit of claim 1, wherein the second voltage is lower than the first voltage and is higher than the third voltage.

3. An integrated circuit, comprising:
an active internal voltage generation unit configured to generate an active voltage and output the active voltage through an internal voltage terminal in an active operation period;
a first standby internal voltage generation unit configured to generate a first standby voltage and output the first standby voltage through the internal voltage terminal in an initial section of a standby operation period; and
a second standby internal voltage generation unit configured to generate a second standby voltage and output the second standby voltage through the internal voltage terminal in the remaining section of the standby operation period,
wherein the first standby internal voltage generation unit and the second standby internal voltage generation unit generate the first standby voltage and the second standby voltage in the standby operation period.

4. The integrated circuit of claim 3, wherein the first standby voltage is lower than the active voltage and is higher than the second standby voltage.

5. The integrated circuit of claim 3, wherein the active internal voltage generation unit comprises:
a comparison type voltage generation unit configured to have a feedback loop formed therein and to generate the active voltage corresponding to a first reference voltage through a comparison operation; and
a first voltage transfer unit configured to transfer an output voltage of the comparison type voltage generation unit to the internal voltage terminal.

6. The integrated circuit of claim 5, wherein the comparison type voltage generation unit comprises:
a comparison unit configured to compare a feedback voltage, corresponding to the active voltage, with the first reference voltage with in the active operation period;
a driving unit configured to generate the active voltage in response to an output signal of the comparison unit; and
a feedback unit configured to generate the feedback voltage using the active voltage.

7. The integrated circuit of claim 3, wherein the first standby internal voltage generation unit comprises:
a first short circuit type voltage generation unit configured to have no feedback loop formed therein and to generate the first standby voltage corresponding to a second reference voltage through a short circuit operation; and
a second voltage transfer unit configured to transfer an output voltage of the first short circuit type voltage generation unit to the internal voltage terminal.

8. The integrated circuit of claim 7, wherein the first short type circuit voltage generation unit outputs the second reference voltage as the first standby voltage in the initial section of the standby operation period.

9. The integrated circuit of claim 3, wherein the second standby internal voltage generation unit comprises:
a second short circuit type voltage generation unit configured to have no feedback loop formed therein and configured to generate the second standby voltage corresponding to a third reference voltage through a short circuit operation; and
a third voltage transfer unit configured to transfer an output voltage of the second short circuit type voltage generation unit to the internal voltage terminal.

10. The integrated circuit of claim 9, wherein the second short circuit type voltage generation unit outputs the third reference voltage as the second standby voltage in the remaining section of the standby operation period.

11. The integrated circuit of claim 5, further comprising a control signal generation unit configured to generate a control signal for controlling the first voltage transfer unit according to the active operation and the standby operation.

12. The integrated circuit of claim 7, further comprising a control signal generation unit configured to generate a control signal for controlling the second voltage transfer unit according to the active operation and the standby operation.

13. The integrated circuit of claim 9, further comprising a control signal generation unit configured to generate a control signal for controlling the third voltage transfer unit according to the active operation and the standby operation.

14. A method of operating an integrated circuit, comprising:
driving an internal voltage terminal with an active voltage in an active operation period;
driving the internal voltage terminal with a first standby voltage in a standby operation period; and
driving the internal voltage terminal with a second standby voltage having a voltage value between a voltage value of the active voltage and a voltage value of the first standby voltage in an initial section of a standby operation period,
wherein the first standby voltage and the second standby voltage drive the internal voltage terminal in the standby operation period.

15. The method of claim 14, wherein the driving the internal voltage terminal with the second standby voltage having a voltage value between a value of the active voltage and a value of the first standby voltage in an initial section of the standby operation period comprises entering the standby operation period after the active operation period.
